(19) United States
(12) Patent Application Publication
(10) Pub. No.: US 2011/0300463 A1
(43) Pub. Date: Dec. 8, 2011

(54) CONTROL EQUIPMENT FOR INTENDING AN ACTUAL FUEL CONVERSION FOR A GAS CELL ARRANGEMENT PROCEDURE FOR THE DETERMINATION OF A FUEL CONVERSION OF A GAS CELL ARRANGEMENT AND GAS CELL ARRANGEMENT

(75) Inventors: Andreas Reinert, Dresden (DE); Thomas Strohbach, Dresden (DE)

(73) Assignee: Staxera GmbH, Dresden (DE)

(21) Appl. No.: 12/792,293

(22) Filed: Jun. 2, 2010

(51) Int. Cl. H01M 8/04; H01M 8/24

(52) U.S. Cl. 429/432

(57) ABSTRACT

The present invention describes a control device for determining an actual fuel turnover for a fuel cell arrangement comprising a voltage reception device for receiving values of a voltage applying over the fuel cell arrangement, a fuel flow setting device for setting a flow of fuel supplied or suppliable to a fuel cell arrangement and/or a current setting device for setting an electrical current output by the fuel cell arrangement, as well as a memory for storing calibration data describing a nominal relation between the fuel turnover of the fuel cell arrangement and a voltage applying over the fuel cell arrangement. The control device is adapted to receive a first voltage value; to control a variation of the flow of fuel supplied to the fuel cell arrangement and/or the current output by the fuel cell arrangement after receiving the first voltage value; and to receive a second voltage value after the variation. In addition, the control device is adapted to determine the actual fuel turnover of the fuel cell arrangement based on the first voltage value, the second voltage value and the calibration data. Moreover, the invention pertains to a corresponding method and a fuel cell arrangement.

The present invention relates to a method for determining a fuel turnover of a fuel cell arrangement as well as a control device for implementing the method and a fuel cell arrangement, in particular a fuel cell stack.

During the operation of fuel cell arrangements, in particular of fuel cell stacks or fuel cell racks, i.e. arrangements of fuel cells stacked behind each other or next to each other, it is important to know and control the operating conditions of the fuel cells as precisely as possible to be able to provide an operation as efficient and economical as possible. For this purpose, different operational parameters of a fuel cell arrangement are monitored.

JP-110970049 A, for example, describes to monitor a voltage drop of the fuel cell stack to predict its service time to avoid inefficient operation of a fuel cell stack whose service time has expired.

To provide efficient operation, it is usually required to set the fuel turnover of the fuel cell arrangement as precisely as possible according to operational requirements. The fuel turnover describes the ratio between the amount of fuel which is converted chemically to produce electricity to the total amount of fuel supplied to the fuel cell arrangement. In particular for micro-fuel cell systems for combined heat and power generation (CHP), e.g. a high electrical degree of efficiency is an important factor for its operating efficiency. For a high electrical degree of efficiency, a high fuel turnover is required. For systems in which fuel cell arrangements are combined with a steam turbine and a gas turbine, depending on the operating state it may be advantageous to operate the fuel cell arrangement with a relatively low fuel turnover. In this case it is too required to be able to know and control the fuel turnover as precisely as possible.

The fuel turnover U_{B} of a fuel cell arrangement is generally determined using the relation

U_{B}=(φᵢₙ−φₒᵤₜ)/φᵢₙ,

wherein Φᵢₙ denotes the amount of fuel flow supplied to the fuel cell arrangement and Φₒᵤₜ denotes the amount of fuel flow flowing out of the fuel cell arrangement. Accordingly, to determine U_{B}, it is thus required to determine the amount of fuel supplied to the fuel cell and the amount of fuel output by it. Usually, this is achieved by measuring the volume flow of fuel supplied and the volume flow of fuel output using volume flow measuring devices. In the case that the fuel is not in its pure form, it may be required to determine corresponding fuel concentrations. This case can e.g. occur when a reformat is used as fuel instead of pure hydrogen gas. Alternatively, mass flows are occasionally measured instead of volume flows.

Sensors to measure volume or mass flows, however, are relatively expensive components which increase the system costs for a fuel cell arrangement and, thus, have a disadvantageous effect on their competitiveness. This is particularly relevant for relatively small systems provided for decentralized production of electrical power.

Furthermore, sensors to measure volume or mass flows, for example of gases, and proportional valves to control volume flows only show a limited accuracy. They also suffer from aging processes, which can lead e.g. to a drift appearing for a mass flow measurement device over its service time, negatively affecting its measuring accuracy.

Such effects may cause that, during control of a process in a fuel cell arrangement, a fuel turnover is being set which does not correspond to the desired fuel turnover (nominal value). In particular, when fuel cell arrangements are operated with a high fuel turnover close to a 100%, a turnover higher than the nominal value can lead to degradation and/or destruction of the fuel cell arrangement such that lasting damage of the fuel cell arrangement is caused. However, if the actual fuel turnover is lower than desired, a lower degree of efficiency of the fuel cell arrangement when producing electrical power results.

To avoid an undesired deviation of an actual fuel turnover from its nominal value, usually the units to control or regulate a flow of fuel in a fuel cell arrangement, e.g. associated devices and valves, are regularly maintained and/or calibrated. Such maintenance occurs in determined intervals and increases the operating cost of a fuel cell arrangement.

It is an object of the present invention to solve the above-mentioned problems and, in particular, to provide a possibility to reduce the maintenance requirements of fuel cell arrangements.

In the following, a fuel cell arrangement generally refers to an arrangement with at least one fuel cell, i.e. an element with an electrolyte, and anode and a cathode in which chemical energy is converted directly into electrical power utilizing a catalyzer. The term fuel cell arrangement thus includes a single such element as well as an arrangement of a plurality of such fuel cells. In particular, the term fuel cell arrangement includes a so-called fuel cell rack or fuel cell stack, in which a plurality of fuel cells are connected in series or parallel to provide a higher output voltage than a single cell. A material flow denotes the flow of a quantity of material; in practice, a flow of a quantity of material is set via regulating its mass or volume flow. Fuel denotes any kind of fuel used in a fuel cell arrangement. In particular, fuel may be a fuel gas like hydrogen gas, reformat, or a fuel having multiple phases.

The present invention is based on the recognition that the ratio of the amount of chemically converted fuel to the amount of fuel supplied in a fuel cell arrangement, namely the fuel turnover U_{B} (which for the case that fuel gas is used as fuel is also called BGU=Brenngasumsatz, German for fuel gas turnover) may be written as

$${U}_{B} = BGU = \frac{{\dot{n}}_{verb}}{{n}_{in}} . \qquad ( Equation 1 )$$

\dot{n}_{verb} denotes the time derivative of the used-up fuel in mol (the amount of material), and
\dot{n}ᵢₙ denotes the time derivative of the amount of supplied fuel in mol. Further, Faraday's efficiency η_{F} may be written as

$${η}_{F} = \frac{I}{{n}_{verb} \cdot z \cdot F} . \qquad ( Equation 2 )$$

I denotes the current output by the fuel cell arrangement in question, z denotes the number of electron transmissions occurring per reaction (which depends on the chemical reaction occurring in the respective fuel cell arrangement and which may be assumed to be known for a given fuel cell type) and F denotes Faraday's constant. Assuming Faraday's efficiency to be η_{F}=1, this altogether leads to

$$\frac{{U}_{B} \cdot {\dot{n}}_{in}}{I} = const . \qquad ( Equation 3 ) .$$

The assumption that η_{F}=1 holds is usually justified unless leakages or other fuel losses not associated with the chemical reaction for the production of electrical power occur in the fuel cell arrangement.

The basic idea of the invention is that it is not necessary to directly measure supplied and output flows of material amounts to determine an actual fuel turnover of a fuel cell arrangement. Rather, knowing the nominal relation between the voltage applying over a fuel cell arrangement and the fuel turnover, it is possible to determine the actual fuel turnover through variation of the parameters appearing in equation 3 (i.e. in particular the current and the flow of the amount of material supplied) and measuring the corresponding voltage change. This is based on the fact that the voltage of a fuel cell arrangement depends on the fuel turnover. For the case that only one of the parameters is varied while the other parameters are kept constant, when the fuel turnover does not follow the nominal relation, a distinct change in the voltage-fuel turnover characteristic line appears, which is easy to interpret and from which the actual fuel turnover may be determined. According to the invention, the exact construction of the fuel cell arrangement is not important. The invention may be applied to all types of fuel cell arrangements, regardless whether oxide ceramic fuel cells, alkaline fuel cells or other types of fuel cells are used.

The present invention describes a control device for determining an actual fuel turnover for a fuel cell arrangement comprising a voltage reception device for receiving values of a voltage applying over a fuel cell arrangement, a fuel flow setting device for setting a flow of fuel supplied or suppliable to the fuel cell arrangement and/or a current setting device for setting an electrical current output by the fuel cell arrangement, as well as a memory to store calibration data corresponding to a nominal relation between a fuel turnover of the fuel cell arrangement and a voltage applying over the fuel cell arrangement. The control device is adapted to receive a first voltage value; to control, after receiving the first voltage value, a variation of the flow of fuel supplied to the fuel cell arrangement and/or of the electrical current output by the fuel cell arrangement; and to receive a second voltage value after the variation. Moreover, the control device is adapted to determine the actual fuel turnover of the fuel cell arrangement based on the first voltage value, the second voltage value, and the calibration data. Thus, sensors already present, such as voltage sensors, are used to determine an actual fuel turnover in a simple manner. Thereby, expensive and inaccurate sensors for determining flows of material may be omitted. Alternatively, the control device may, of course, be used in addition to already known sensors without difficulty in order to provide an independent additional possibility for determining the fuel turnover. Moreover, the control device enables a simple calibration of a fuel cell arrangement by receiving a plurality of voltage values. In particular, devices to control a fuel supply such as valves, pumps, pipe systems and the like may be calibrated without much effort. Most notably, such calibration is possible during continuing operation without a maintenance cycle having to be carried out, during which the fuel cell arrangement cannot be used.

For determining the actual fuel turnover, preferably equation 3 is used. In addition, the actual flow of amount of fuel may be determined. For variations of one of the parameters current or flow of fuel, it is particularly advantageous to keep the respective other parameter and further operational parameters of the fuel cell arrangement constant, to cause a reaction of the fuel cell arrangement resulting solely from the deliberate variation of one parameter.

The current setting device may be adapted such that it sets a load connected to the fuel cell arrangement or an electrical resistance, respectively, to set the current output by the fuel cell arrangement in a simple way. When varying the current, compared to varying a flow of fuel, an additional voltage drop caused by resistive effects appears. This additional effect, which is governed by Ohm's law, has to be considered when determining the fuel turnover based on the measured voltage values.

The control device preferably comprises a microprocessor which is connected via defined interfaces with one or more voltage sensors measuring and passing on to the control device the voltage applying over the fuel cell arrangement. In addition, the microprocessor and/or the control device may be connected to an electric load such that the load may be set via control commands of the microprocessor. The calibration data may be stored in a commonly known memory accessible to the microprocessor, like e.g. a RAM. Alternatively, the data may be stored in any suitable way, in particular in a permanent memory like an EPROM, an EEPROM, on a magnetic memory like e.g. a hard disk or any other storage medium.

In particular, the calibration data may describe the nominal value at constant electrical current. It may also be considered that the calibration data describes the nominal relation at constant flow of fuel. In addition, it may be advantageous to store data additional to the calibration data for determining the actual fuel turnover, for example, data relating to voltage-fuel turnover relations deviating from the nominal value. In particular, different characteristic lines of voltage-fuel turnover relations may be stored to enable determining an actual fuel turnover in a particularly easy way.

In a preferred embodiment, it is considered that the control device is configured to determine the actual fuel turnover based on additional voltage values received by the voltage reception device. In particular, the additional voltage values should correspond to additional variations of the flow of fuel and/or the current. In this way, the accuracy of the fuel turnover determination may be increased.

It is envisioned that the control device in a particularly preferred embodiment is configured to set the flow of fuel at constant current to a target value at which the actual voltage-fuel turnover relation goes through a characteristic transition. Analogously, the control device may be configured to set the current at constant flow of fuel to a target value at which the actual voltage-fuel turnover relation undergoes a characteristic transition. It is advantageous if the control device is configured to receive a voltage value corresponding to the target value as first voltage value. The characteristic transitions of the voltage-fuel turnover relation of a fuel cell arrangement are particularly well-suited to uniquely identify measurement points, thus providing an increased accuracy of the fuel turnover determination. In particular, it may be advantageous to set a target value at which an actual voltage-fuel turnover characteristic line shows a strong voltage drop. Such a drop occurs in many fuel cell arrangements at a fuel turnover of typically approximately 99%.

It is considered to be particularly advantageous if the control device is configured to determine the actual fuel turnover based on a slope calculated from the received voltage values. The slope may, for example, be associated to a given voltage-fuel turnover characteristic line and given fuel turnover values. By utilizing the slope, errors of the determination of the fuel turnover are reduced. This is particularly true if more than two voltage values are utilized for the determination of the slope.

The present invention also refers to a method for determining an actual fuel turnover of a fuel cell arrangement with the steps of providing predetermined calibration data for a relation between a fuel turnover of the fuel cell arrangement and a voltage applying over a fuel cell arrangement, sensing a first voltage applying over the fuel cell arrangement, varying a flow of fuel supplied to the fuel cell arrangement and/or a current output by the fuel cell arrangement, as well as sensing a second voltage applying over the fuel cell arrangement after the step of varying and determining the actual fuel turnover of the fuel cell arrangement based on the first voltage, the second voltage and the calibration data.

The calibration data may describe the nominal relation at constant electrical current and/or the nominal relation at constant flow of fuel. In addition, determining of the actual fuel turnover may be performed based on additional voltage values received or sensed by a voltage reception device.

It is advantageous if the flow of fuel at constant current or the current at constant flow of fuel is set to a target value at which the actual voltage-fuel turnover relation undergoes a characteristic transition. In particular, a voltage value corresponding to the target value may be received as a first voltage value. The target value may correspond to a fuel turnover of approximately 99%, if a characteristic drop in the voltage-fuel turnover characteristic line occurs there.

Furthermore, according to the method, the actual fuel turnover may be determined based on a slope calculated from the received voltage values.

The method is particularly suited for application to a fuel cell arrangement if the fuel cell arrangement is the fuel cell stack. Such a stack or rack usually already comprises at least one voltage sensor sensing the voltage over the stack, which may be used for the implementation of the method.

The fuel cell arrangement to which the method is applied may also be a single fuel cell or comprise two or more fuel cells. In particular, the fuel cells may be part of a fuel cell stack. In this manner, the fuel turnover and, thus, the capacity of a part of the fuel cell stack may be determined.

The invention also pertains to a fuel cell arrangement with a measurement device to sense a voltage applying over the fuel cell arrangement and a control device as described above. The fuel cell arrangement may be a fuel cell stack or a fuel cell. It may also comprise two or more fuel cells which preferably form part of a fuel cell stack.

It may be particularly advantageous to apply the method to different subdivisions of a superordinate fuel cell arrangement. For example, it is possible to apply the invention not only to a fuel cell stack as a whole. An inventive determination of the fuel turnover of one or more subunits of the stack may also be performed. In this case, the subunits are formed of one fuel cell or a plurality of fuel cells. Thus, the capability of a stack may be monitored on several levels. In particular, individual faulty cells or subunits may be identified. In this context, it may be considered that the value of the voltage applying over these cells or subunits is passed on to the control device, and a corresponding nominal relation between voltage and fuel turnover is provided.

It is possible that the nominal relation is given by a theoretical model or that it is determined via measurement. In particular, it may be appropriate to determine the nominal relation shortly after manufacturing a fuel cell arrangement. It may be advantageous to provide a common nominal relation for fuel cell arrangements of a common type, e.g. stemming from a volume production, if it can be assumed that the fuel cell arrangements in question ideally show a comparable behavior.

The invention will now be illustrated with reference to the drawings of particularly preferred embodiments.

They show:

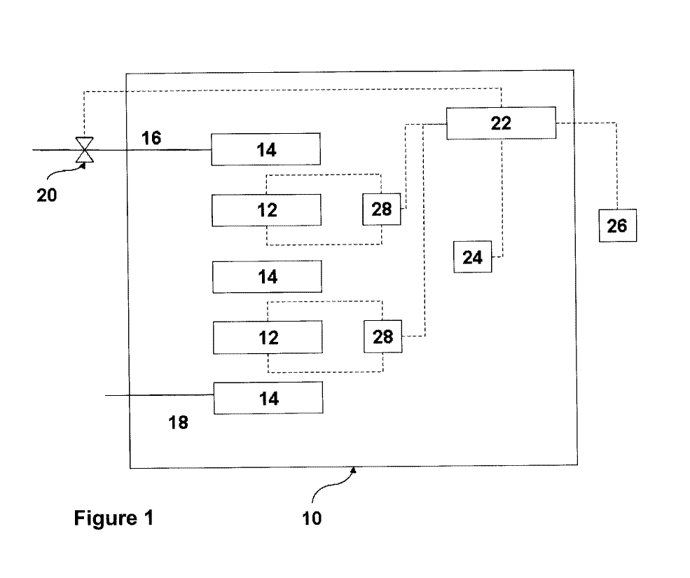

FIG. 1 a schematic illustration of a fuel cell stack;

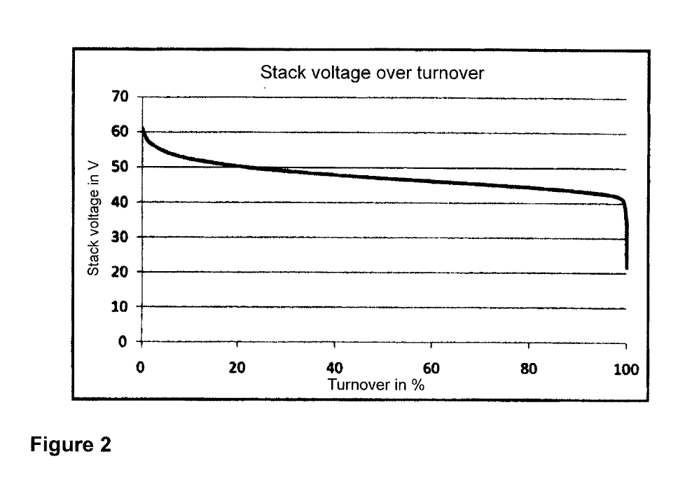

FIG. 2 an exemplary curve of the voltage of a fuel cell stack over the fuel turnover;

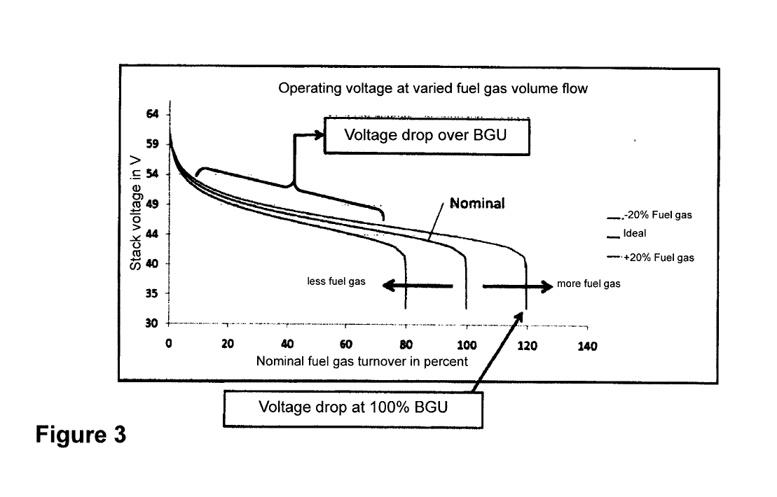

FIG. 3 exemplary characteristic lines of the voltage-fuel turnover relation for different fuel turnovers deviating from the nominal value;

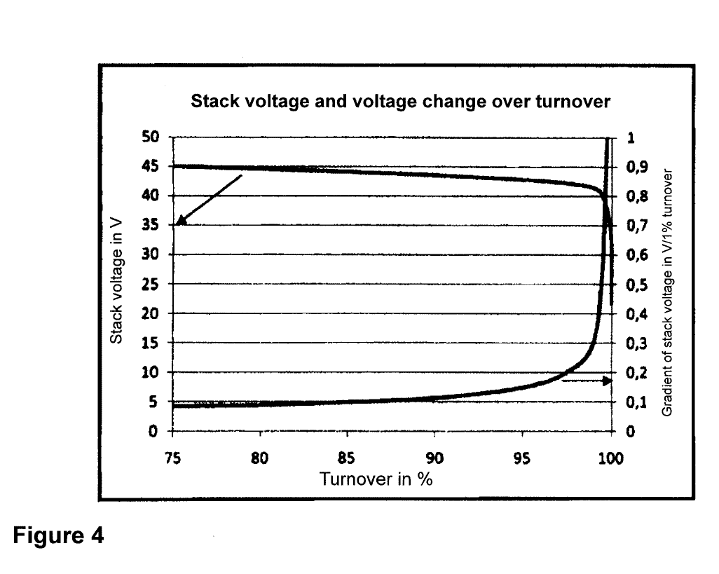

FIG. 4 an exemplary curve of the stack voltage and the change of stack voltage over the fuel turnover;

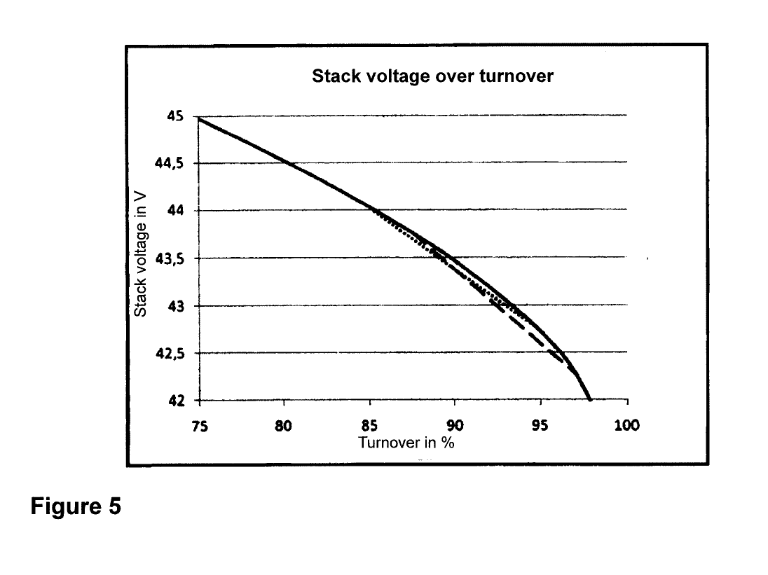

FIG. 5 by way of example, the different slopes of chords between two points on a characteristic line of a voltage-fuel turnover characteristic line; and

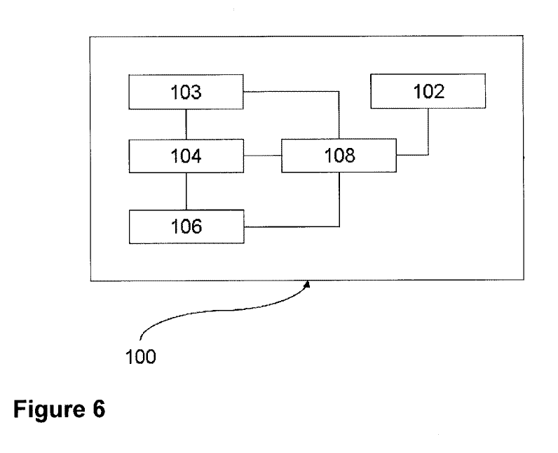

FIG. 6 a schematic illustration of a control device.

FIG. 1 schematically shows a fuel cell stack 10. Connections for electrical current are shown dashed, whereas connections for carrying fuel are shown as continuous lines. For reasons of clarity, not all components usually provided in a stack are shown.

The stack 10 comprises several layers of individual fuel cells 12, which are separated from each other in the common way using bipolar plates 14 (or polar plates at the edges). In this example, a fuel gas is used as fuel which is supplied to the stack via a fuel gas supply 16. The remaining fuel gas which did not chemically react in one of the fuel cells 12 leaves the stack 10 via a fuel gas discharge 18. A valve 20 is provided to control the supply of fuel gas. Valve 20 is connected to a control device 22 and may be controlled by the control device 22 for controlling a fuel gas supply. In addition, control device 22 is connected to a voltage sensor 24, which can sense and transmit to the control device 22 the voltage applying over the stack 10.

Moreover, control device 22 is connected to an electrical load 26 through which an electrical current output by the stack 10 flows. The control device 22 is adapted to control the electrical load 26 and, thus, the current output by the stack 10. However, it is not necessary that the control device 22 is adapted to control both the current and the fuel gas supply; rather it may be adapted that it only controls one of those.

Each fuel cell 12 comprises an oxide ceramic electrolyte as well as an anode and a cathode (not shown). Moreover, additional voltage sensors 28 may be provided which preferably sense and transmit to control device 22 the voltage applying over an individual fuel cell 12. It is also possible to provide sensors 28 sensing the voltage over a plurality of fuel cells 12. The bracing of stack 10 is not shown.

FIG. 2 shows in an exemplary manner an example for the curve of a stack voltage in Volt (vertical axis) over the fuel turnover in percent (horizontal axis), i.e. a voltage-fuel turnover characteristic line. It is shown the case in which a volume flow of fuel gas is varied with otherwise constant parameters.

In particular, the resistance and the electrical current output by the fuel cell stack are kept constant, while the volume flow of the fuel gas supplied to the fuel cell stack is varied. With increasing volume flow of fuel gas, an increasing amount of fuel gas is supplied to the anode, causing a variation of the fuel gas turnover. FIG. 2 shows a calibration curve or a nominal value curve for a given fuel cell arrangement, e.g. for a stack 10 as shown in FIG. 1.

Similar curves or characteristic lines result for different types of fuel and fuel cell arrangements. The exact form of a voltage-fuel turnover relation, as schematically shown by way of example, depends on the specific features of the utilized stack and/or the fuel cell arrangement in question. The general shape of the curve, however, is typical for a fuel cell arrangement in that it may be roughly divided in three parts. For low fuel turnover values, there can be recognized an approximately exponentially voltage decline (in this region reaction kinetic effects dominate the characteristic line), which transitions into a linear region corresponding to the region in which resistive effects dominate the shape of the curve. For high fuel turnover values, transport losses increasingly appear, which can lead to a strong drop in voltage. In the case shown, the strong drop occurs at the fuel turnover value of approximately 99%.

FIG. 3 shows based on the curve shown in FIG. 2 deviations from the calibration curve or nominal value curve of FIG. 2 for the case that the actual fuel turnover deviates from the nominal value. The abbreviation BGU stands for fuel gas turnover (German: Brenngasumsatz).

If the actual fuel gas volume flow supplied to the fuel cell arrangement lies over its nominal value, the actual fuel turnover is smaller than it should be according to the nominal value curve of the stack voltage over the turnover for the nominal volume flow of fuel. This results from the fact that at equal current, a larger amount of fuel is brought to the anode, while an equal total number of chemical reactions to produce electrical power occur. Therefore, the rest of unused fuel is larger for a higher volume flow of fuel gas. Hence, a lower fuel turnover results. In contrast, at a lower actual volume flow of fuel, the actual fuel turnover is larger than the fuel gas turnover of the nominal value curve, due to a higher percentage of the fuel, which is available in a lower amount than desired, being converted at the anode.

FIG. 3 shows three curves which are representative for the cases in question. The middle curve with the continuous line corresponds to the nominal curve (nominal or ideal curve) as shown in FIG. 2. In the case that the volume flow of fuel supplied is larger than it should be according to its nominal value (in the example it is assumed that 20% more fuel gas is supplied per time unit), theoretically the curve shown on the right hand side in FIG. 3 results, which in comparison to the nominal value curve is elongated. In the case that the actual fuel volume flow is lower than desired (in the example, 20% less fuel gas per time unit), the nominal value curve is shifted to the left and is compressed. As may be seen particularly well in FIG. 3, not only do the absolute values of the curves change for different volume flows of fuel supplied, but the curves also change their shapes. In particular, their slopes change. The change of slope can be recognized particularly well in the operating region of the fuel cell, shortly before complete fuel turnover is reached. Thus, if the actual turnover deviates from the nominal value, the gradient of the voltage also varies. For example, for a larger volume flow of fuel, i.e. lower fuel turnover, the slope between two fuel turnover values is larger than in the nominal value curve.

This can be seen particularly clearly from FIG. 4, which shows, on one hand, a characteristic line of the stack voltage over the turnover and, on the other hand, the corresponding voltage change for 1% in the region of high fuel turnover (>75%). It can be seen that for a region having fuel turnover of over 95%, the voltage change per percent of turnover is particularly strong.

A further illustration of this relation is shown in FIG. 5, which shows a section of the characteristic line of the stack voltage over the turnover for the exemplary fuel cell stack. The continuous line corresponds to the characteristic line already discussed. The dotted line shows the chord between two points of the characteristic line corresponding to a turnover of 85% and a turnover of 95%, respectively. The dashed line correspondingly shows the chord between two points of the characteristic line corresponding to 87.5% and 97.5% turnover, respectively. As can be easily seen, the slopes of both chords strongly differ despite the relatively small shift in turnover.

From FIGS. 2 to 5, it can be recognized that the actual fuel turnover can be determined and/or a fuel turnover calibration may be performed based on a change of the voltage-fuel turnover characteristic line.

For this purpose, at least two voltage values of the fuel cell arrangement under consideration are taken at different fuel turnover values. In the example described herein, the variation of the fuel turnover is achieved by varying the supplied amount of fuel at otherwise constant parameters. Alternatively, the amount of fuel supplied may be kept constant, but the current output by the fuel cell arrangement may be varied. In this case, during analysis of the voltage-fuel turnover relation it has to be taken into account that the change in voltage comprises a component caused by resistive effects due to the current variation.

A preferred approach comprises to first reduce the flow of fuel (in this case, the volume flow of fuel) from an initial value, the initial value serving to provide a first voltage value, such that the fuel cell arrangement runs into its turnover limit. There, the voltage-fuel turnover relation shows a strong voltage drop, which may be easily identified and typically corresponds to a fuel turnover of 99%. The exact location of this point, however, depends on the construction of the fuel cell arrangement. The value of the voltage corresponding to this characteristic point is well-suited as second voltage value, as it provides a measurement point which is easily identified on the voltage-fuel turnover characteristic line of the actual fuel turnover. In this context, a variation of parameters like the current and/or the flow of fuel is necessary to find the characteristic point. In this approach, the first voltage value inter alia serves to determine the location of characteristic point (which provides a second voltage value).

Now the fuel supply may be increased, thus reducing the fuel turnover. It is useful to reduce the fuel supply as far as it takes to reach a well-defined operation region clearly distinguished over the voltage drop, i.e. at a fuel turnover which is lower by 5% to 10% percentage points. As this point, an additional voltage value may be obtained.

Using the characteristic point, and taking into account the calibration data, a characteristic line representing the fuel cell arrangement may be identified. To improve the accuracy, the first and the additional voltage value or values may also be taken into account.

A further alternative comprises to change the supply of fuel starting from an operating point providing a first voltage value, until a well-recognizable difference in the voltage applying over the fuel cell arrangement occurs. This may be achieved without entering the region around the fuel turnover saturation in which the characteristic voltage drop occurs due to transport losses. It is useful in this alternative to determine voltage values in the linear region of the voltage-fuel turnover characteristic line, which usually with a high level of probability comprises the region of a fuel turnover of approximately 45% to 75%.

Now the deviation of the actual data from the nominal value relation may be determined utilizing equation 3 or the nominal value relation, in particular by comparing the measured data with calibration data of the nominal value relation. It is particularly advantageous to determine more than two voltage values to obtain more measurement points and to increase the accuracy and reliability of the method in this manner.

A further alternative is to determinate the slope of a chord between two measured voltage values. As shown in FIGS. 4 and 5, the slope is very sensitive to variations of the fuel turnover and can be easily utilized to determine the deviation of the actual fuel turnover characteristic line from the nominal value characteristic line. For a sufficient number of measurement points, it is even possible to approximately determine the derivative of the characteristic line, i.e. tangents may be determined. From the slope of the chords and/or the derivative, the actual fuel turnover may be determined by comparison with the nominal value characteristic line and/or corresponding chords or tangents. In this way, it is also possible to calibrate the arrangement.

The control device is adapted to perform the steps of at least one of the alternatives described above to determine the actual fuel turnover and/or for calibration. Instead of controlling and varying the flow of fuel, the current may be varied. In this case, the additional resistance effect is taken into account.

FIG. 7 schematically shows the structure of an exemplary control device 100 for a fuel cell arrangement. The control device 100 may be utilized, for example, in the fuel arrangement shown in FIG. 1.

The control device 100 comprises a voltage reception device 102, which may communicate with one or more voltage sensors to receive voltage values. Furthermore, control device 100 comprises a fuel flow setting device 103 for setting a flow of fuel, which may, for example, be connected to control a proportional valve for supplying fuel. A current setting device 104 may be connected to a current control device for setting an electrical current output by the fuel cell arrangement. The control device 100 comprises a memory 106 for storing the calibration data. It is not necessary that the control device comprises both the fuel flow setting device 103 and the current setting device 104. For determination of the actual fuel turnover, it is sufficient if one of these devices is provided.

A microprocessor 108 communicates with the voltage reception device 102, the fuel flow setting device 103, the current setting device 104 and memory 106. The voltage reception device 102, the fuel setting device 103, and the current setting device 104 may be embodied as specific hardware elements, or they may comprise software components, which may be run by a processor and communicate via interfaces.

The features of the invention disclosed in the above specification, in the figures as well as the claims, may be relevant for the realization of the invention individually or any combination.

### LIST OF REFERENCE NUMERALS

10 Fuel cell stack
12 Fuel cell
14 Polar/Bipolar plate
16 Fuel gas supply
18 Fuel gas outlet
20 Valve
22 Control device
24 Voltage sensor
26 Electrical load
28 Additional voltage sensor
100 Control device
102 Voltage reception device
103 Fuel flow setting device
104 Current device
106 Memory
108 Microprocessor

1. A control device for determining an actual fuel turnover for a fuel cell arrangement, wherein the control device comprises:
a voltage reception device for receiving values of a voltage applying over the fuel cell arrangement;
a fuel flow setting device for setting a flow of fuel supplied or suppliable to the fuel cell arrangement and/or a current setting device for setting an electrical current output by the fuel cell arrangement; and
a memory for storing calibration data corresponding to a relation between a fuel turnover of the fuel cell arrangement and a voltage applying over the fuel cell arrangement;
wherein the control device is adapted to receive a first voltage value;
to control, after reception of the first voltage value, a variation of the flow of fuel supplied to the fuel cell arrangement and/or the current output by the fuel cell arrangement; and
to receive a second voltage value after the variation; and
wherein the control device is further adapted to determine the actual fuel turnover of the fuel cell arrangement based on the first voltage value, the second voltage value, and the calibration data.

2. The control device of claim 1, characterized in that the calibration data describe the nominal relation at constant current.

3. The control device of claim 1, characterized in that the calibration data describe the nominal relation at a constant flow of fuel.

4. The control device of claim 1, characterized in that the control device is adapted to determine the actual fuel turnover based on additional voltage values received by the voltage reception device.

5. The control device of claim 1, characterized in that the control device is adapted to set at constant current the flow of fuel to a target value at which the actual voltage-fuel turnover relation undergoes a characteristic transition.

6. The control device of claim 5, characterized in that the control device is adapted to receive a voltage value corresponding to the target value as first voltage value.

7. The control device of claim 5, characterized in that the target value corresponds to a fuel turnover of 99%.

8. The control device of claim 1, characterized in that the control device is adapted to set at constant flow of fuel the current to a target value at which the actual voltage-fuel turnover relation undergoes a characteristic transition.

9. The control device of claim 8, characterized in that the control device is adapted to receive a voltage value corresponding to the target value as first voltage value.

10. The control device of claim 8, characterized in that the target value corresponds to a fuel turnover of approximately 99%.

11. The control device of claim 1, characterized in that the control device is adapted to determine the actual fuel turnover based on a slope calculated from the received voltage values.

12. A method for determining an actual fuel turnover of a fuel cell arrangement, comprising the steps of:
providing predetermined calibration data for a relation between a fuel turnover of the fuel cell arrangement and a voltage applying over the fuel cell arrangement;
sensing a first voltage applying over the fuel cell arrangement;
varying a flow of fuel supplied to the fuel cell arrangement and/or a current output by the fuel cell arrangement;
sensing a second voltage applying over the fuel cell arrangement after the step of varying; and
determining the actual fuel turnover of the fuel cell arrangement based on the first voltage, the second voltage and the calibration data.

13. The method of claim 12, characterized in that the calibration data describe the nominal value at constant current.

14. The method of claim 12, characterized in that the calibration data describe the nominal value at constant flow of fuel.

15. The method of claim 12, characterized in that determining the actual fuel turnover is performed based on additional voltage values received by a voltage reception device.

16. The method of claim 13, characterized in that the flow of fuel is set at a constant current to a target value at which the actual voltage-fuel turnover relation undergoes a characteristic transition.

17. The method of claim 16, characterized in that a voltage value corresponding to the target value is received as first voltage value.

18. The method of claim 17, characterized in that the target value corresponds to a fuel turnover of 99%.

19. The method of claim 14, characterized in that the current is set at constant flow of fuel to a target value at which the actual voltage-fuel turnover relation undergoes a characteristic transition.

20. The method of claim 19, characterized in that a voltage value corresponding to the target value is received as first voltage value.

21. The method of claim 20, characterized in that the target value corresponds to a fuel turnover of 99%.

22. The method of claim 12, characterized in that the actual fuel turnover is determined based on a slope calculated from the received voltage values.

23. The method of claim 12, characterized in that the fuel cell arrangement is a fuel cell stack.

24. The method of claim 12, characterized in that the fuel cell arrangement is a fuel cell.

25. The method of claim 12, characterized in that the fuel cell arrangement comprises two or more fuel cells.

26. The method of claim 25, characterized in that the fuel cells are part of fuel cell stack.

27. A fuel cell arrangement with a measuring device for detecting a voltage applying over the fuel cell arrangement; and
a control device of claim 1.

28. The fuel cell arrangement of claim 27, characterized in that the fuel cell arrangement is a fuel cell stack.

29. The fuel cell arrangement of claim 27, characterized in that the fuel cell arrangement is a fuel cell.

30. The fuel cell arrangement of claim 27, characterized in that the fuel cell arrangement comprises two or more fuel cells.

31. The fuel cell arrangement of claim 30, when the fuel cells are part of a fuel cell stack.
